(19) United States
(12) Patent Application Publication
(10) Pub. No.: US 2002/0084783 A1
(43) Pub. Date: Jul. 4, 2002

(54) Apparatus for inspecting flat goods made of polymeric materials with embedded textile reinforcements

(76) Inventors: Bernhard Blumich, Roetgen (DE); Michael Bruder, Hamburg (DE); Thomas Guerlin, Neustadt (DE); Pablo Prado, San Diego, CA (US)

Correspondence Address: Klaus J. Bach, 4407 Twin Oaks Drive, Murrysville, PA, 15668, US

(21) Appl. No.: 10/026,067

(22) Filed: Dec. 18, 2001

Related U.S. Application Data
(63) Continuation-in-part of application No. PCT/EP00/05580, filed on Jun. 16, 2000.

(30) Foreign Application Priority Data
Jun. 20, 1999 (DE) 199 28 039.8

(51) Int. Cl. G01V 3/00

(52) U.S. Cl. 324/322; 324/309; 324/318; 324/307

(57) ABSTRACT

In an apparatus for examining flat goods of polymeric material having reinforcement structures embedded therein, a number of NMR-MOUSE probes are provided on a measuring surface of an examining body for nuclear magnetic resonance imaging analysis of the flat goods.

This is a Continuation-In-Part application of international application PCT/EP00/05580 filed Jun. 16, 2000 and claiming the priority of German application 199 28 039.8 filed Jun. 20, 1999.

### BACKGROUND OF THE INVENTION

The invention relates to an apparatus for inspecting flat goods of polymeric materials provided with textile reinforcements.

Flat goods of polymeric materials, which include embedded therein textiles for reinforcement and shaping, are well known. Flat goods of such polymeric materials comprising elastomers, thermoplastic elastomers, thermoplasts and duroplasts are used especially in roof coverings, as printing sheets, conveyor belts, membranes and as cylindrical flatware such as air springs, hoses and pressure compensators.

It is important to determine the quality of such flat goods, particularly important are examinations in which the location of the reinforcements in the polymeric material can be determined. So far, the material is examined by the following methods: Destructive statistical examination methods and non-destructive methods by x-ray examinations.

It is the object of the present invention to provide a method by which such flat goods can be thoroughly examined in a non-destructive manner for determining the arrangement and the location of the reinforcements in the polymeric material. In particular, undesirable fault locations such as non-uniform distances between reinforcement layers or missing reinforcement structures should be determinable. The examination method should be non-destructive, that is, the quality of the flat goods should not be affected by the examination. The apparatus should further be simple in design and provide for good resolution.

### SUMMARY OF THE INVENTION

In an apparatus for examining flat goods of polymeric material having reinforcement structures embedded therein, a number of NMR-MOUSE probes is provided on a measuring surface of an examining body for nuclear magnetic resonance imaging analysis of the flat goods.

NMR-MOUSE probes (Nuclear-Magnetic Resonance MObile Universal Surface Explorer) are known in the material research (see G. Eidmann et al. “The NMR-MOUSE, a Mobile Universal Surface Explorer”, Journal of Nagnetic Resonance (J, Man. Res.) A 122, 1996, p. 104/109, and also A. Guthausen et al., “Analysis of Polymer Materials by Surface NMR via the MOIJSE”, J. Magn. Reson. A 129, 1997, p. 001/007, and A. Guthausen et al, “NMR Bildgebung und Materialforschung”, Chemie unserer Zeit, 1998, p. 73/82. With NMR-MOUSE probes an NMR signal is generated in an area adjacent the probe surface, which signal is measured for the characterization of the properties of the materials in the vicinity of the surface adjacent the NMR-MOUSE probe. Flat goods of polymeric material with textile reinforcements consist, as far as the practical measurement of the nuclear magnetic resonance of the hydrogen atom 1H (1H-NMR) is concerned, of a material representing signal providing areas, that is the polymeric material, and of a material which—like the textile reinforcements - does not generate any signal. For the examination of the position of the textile reinforcements in the polymeric material, the imaging of the spin density is sufficient which is relatively simple under normal experimental conditions. The introduction of a relaxation contrast is not absolutely necessary for the evaluation of the examination results, but it is not disturbing either.

In addition to the normally measured nucleus 1H for the examination of the flat goods with NMR-MOUSE probes also the nucleus 19F may be considered. If 19F is present only in the material of the textile reinforcements, the textile reinforcement structures can be directly depicted by 19F-NMR.

The analysis of the flat goods of polymeric material with textile reinforcements by NMR-MOUSE probes is particularly advantageous because the measuring sensitivity is particularly high for a low depth of the measuring-sensitive volume of the probe (for example, up to 3 mm) and 2) soft materials such as polymers are particularly suitable for the NMR measurement. If a homogeneous magnetic polarization field B0 and a homogeneous magnetic high frequency field B1 are not needed, the NMR-MOUSE probes can be small in comparison with the common NMR apparatus.

In another embodiment according to the invention, a planar measuring area is formed on a measuring body by NMR-MOUSE probes for supporting the flat goods. In order to be able to examine the flat good as thoroughly as possible in a particular direction within the material, the NMR-MOUSE probes are arranged in the measuring plane in overlapping relationship particularly in such a way that their measuring sensitive volume areas overlap in this particular direction.

If only the 1H density is depicted, the measurement can take place at an elevated temperature at which the rubber molecules have an increased thermal motion. The flat goods are therefore examined in a warm state. The examination may take place during, or immediately after, the manufacturing process, such as the vulcanization. The examination temperature is limited by the Curie-temperature of the material; the temperature of the flat goods must be below the Curie temperature. There is a gain in measuring sensitivity associated with this measuring procedure but, on the other hand, there may be a loss in contrast because of the different NMR-relaxation times. However, an increase in the measuring sensitivity is of greater importance for the flat goods to be examined.

Advantageous embodiments of the invention will be described below in greater detail on the basis of the accompanying schematic drawings.

### BRIEF DESCRIPTION OF THE DRAWINGS

FIG. 1 shows a cylindrical measuring body with NMR-MOUSE probes,

FIG. 2 shows a section of an areal measuring body with NMR-MOUSE probes,

FIG. 3a is a plain view of a NMR-MOUSE probe taken in the direction a-a of FIG. 3b,

FIG. 3b is a cross-sectional view of the NMR-MOUSE taken along line b-b of FIG. 3a, and

FIG. 4 shows a measuring example.

### DESCRIPTION OF PREFERRED EMBODIMENTS

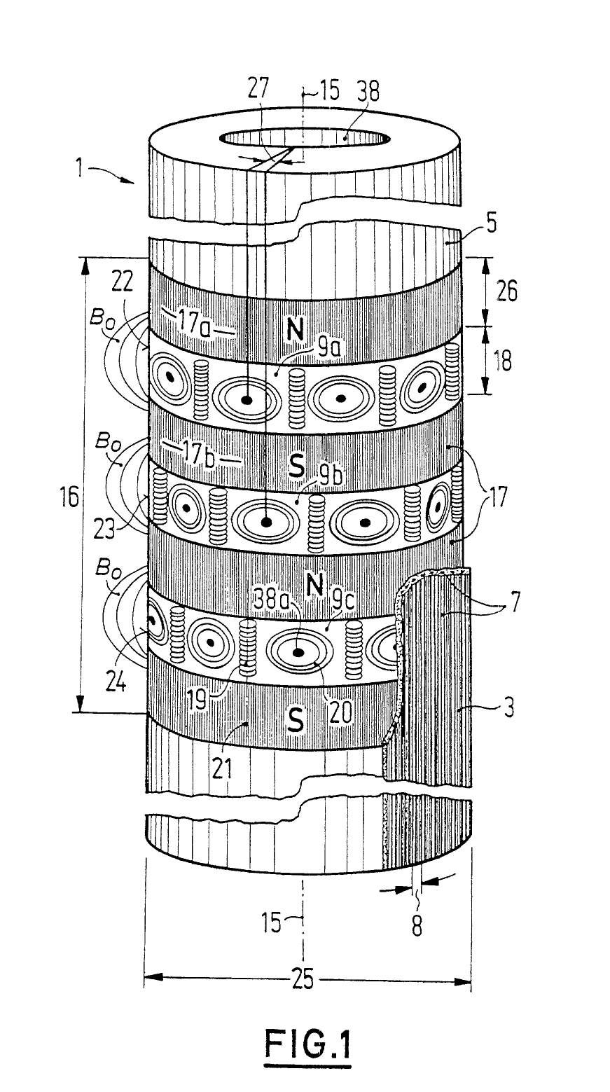

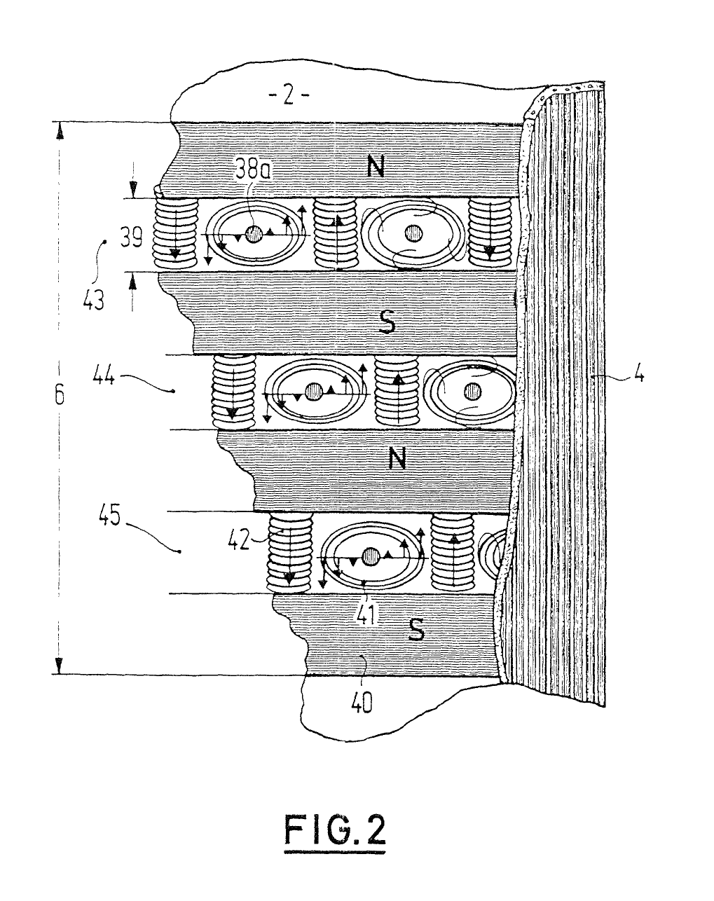

FIGS. 1 and 2 show an apparatus for the examination of flat goods of polymeric material including measuring bodies 1 and 2 provided with NMR-MOUSE probes. The embodiments shown in the drawings are intended for the examination of a pneumatically stressed component (air spring) of natural or synthetic rubber which includes textile reinforcements for increasing its loading capacity. The textile reinforcement in the polymeric material consists for example of aramide fibers or polyamide fibers. Suitable are also polyester fibers, mineral fibers, (for example glass fibers) carbon fibers, fibers of acetylized polyvinyl alcohol, Reon fibers (semi-synthetic fibers, for example, with cellulose) or, for example, cotton.

The reinforcements embedded in the polymeric material are fibers of a material which has a lower 1H- or 19F-density than the polymeric base material in which they are embedded or which has different NMR relaxation times.

The measuring body 1, which is cylindrical, is particularly suitable for examining hose-like goods. The measuring body 2 is suitable for examining flat material shirts 4. With the measuring body 1, the hose-like good is pulled over the cylinder surface 5; with the measuring body 2, the flat material is placed onto the planar measuring surface 6. Only small parts of the hose-like goods and the material sheet to be tested are shown in FIGS. 1 and 2.

The polymeric material is penetrated by reinforcement fibers 7 whose position in the flat goods 3 and 4 is only schematically shown in the drawings. In the embodiment, the reinforcement fibers 7 extend through the material in parallel relationship in this spacing 8 and in a predetermined direction. In the embodiment shown, the fibers extend parallel to the longitudinal axis of the hose or sheet-like flat goods 3 and 4, respectively. The distance 8 between the parallel reinforcement fibers 7 is 0.5 to 10 mm.

However, the reinforcement fibers embedded in the material may also be arranged in ways different from that shown in FIGS. 1 and 2; they may cross each other or extend in a net-like fashion.

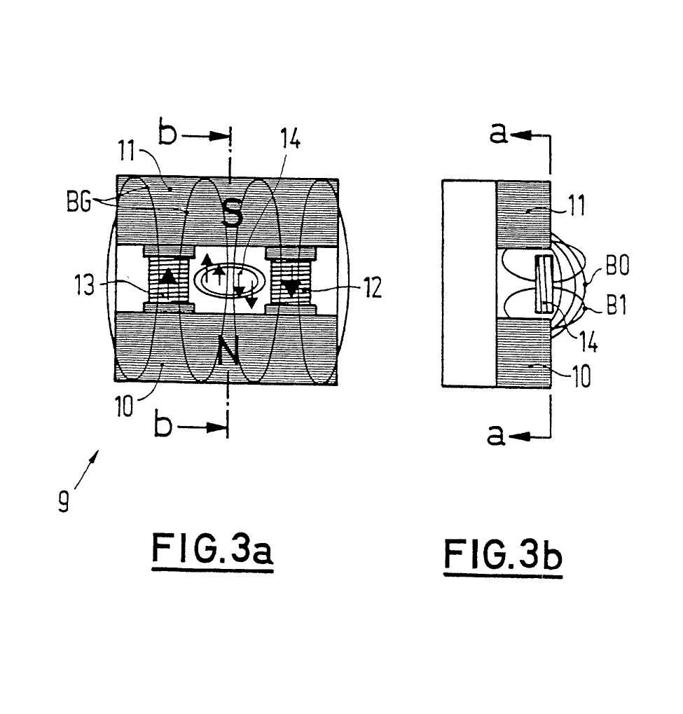

For the examination of the arrangement and disposition of the reinforcements in the polymer material especially for determination of undesirable fault locations such as non-uniform fiber distances or missing fibers, which would detrimentally affect the strength of the material as required for a particular application, NMR-MOUSE probes are provided in the measuring bodies 1 and 2. The design of such a NMR-MOUSE probe is shown in principle in FIGS. 3a and 3b.

A NMR-MOUSE probe has spatially inhomogeneous fields for the polarization of the nuclear magnetic moments in the material to be examined and for the generation of measuring signals. As apparent from FIG. 3, two gradient coils 12, 13 are disposed in a NMR-MOUSE probe 9 between two oppositely magnetized permanent magnets 10, 11 with magnet poles N and S and a radio frequency coil 14 is disposed between the gradient coils.

The static polarization field B0, which is generated between the permanent magnetic poles, can be overlayed, by means of the radio frequency coil 14, in a pulsed fashion, by a magnetic measuring field B1, as the magnetic component of a radio frequency field which is formed by the radio frequency coil as part of an electric oscillation circuit and which is sensed.

Under “pulses” of the magnetic measuring field, it is to be understood that the magnetic field is generated in a time-pulsed fashion by excitation of the radio frequency coil for short periods. With the gradient coils 12, 13, a magnetic gradient field BG is superimposed on the magnetic field—also in a pulsed fashion. FIG. 3a shows schematically the field lines of the gradient field BG. Shape and size of the surrounding volume which is nuclear-magnetically implicated in the area around the NMR-MOUSE probe and which is to be detected by measuring the echo signals and which represents the measuring-sensitive volume area, is defined for each probe, on one hand, by the specific bandwidth of the magnetic radio-frequency excitation and, on the other hand, by the orthogonal components of the two magnetic fields B0 and B1. The course of the magnetic field lines and, consequently, the size of the signal-providing volume area can be changed by the respective dimensions and the arrangement of the permanent magnets and the coil of the electric radio frequency oscillating circuit.

In addition to the permanent magnetic polarization field B0 (basic field), a gradient field BG with a field gradient tangential to the outer surface of the NMR-MOUSE probe 9 and normal to the polarization field B0 is generated by the gradient coils 12, 13. This additional field BG is pulsed—in time—for generating the spatial resolution (phase encoding of the spatial information). The radio frequency coil 14 is so arranged that the field lines of the polarization field B0 and the field lines of the magnetic field B1 generated by the radio frequency coil are disposed normal to one another in the measuring sensitive volume area. The orthogonal components of the two magnetic fields B0 and B1 define the sensitive volume. The same high frequency coil is used for the excitation and for the detection of the measuring signal.

In the embodiment according to FIG. 1, several permanent magnetic rings 17 are provided in the measuring range 16 of the cylindrical measuring area on the cylindrical measuring body 1 which has a cylinder axis 15. These permanent magnetic rings are radially polarized and arranged—when viewed in the direction of the cylinder axis—in spaced relationship (space 18) around the cylinder axis 15 and centered about the axis. Adjacent permanent magnetic rings 17a, 17b are oppositely polarized: In this way, next to the permanent magnetic ring 17a the magnetic field of which extends in magnetic north-south direction from the outside radially inward (the magnetic north pole N of the permanent magnetic ring 17a is formed by the outer ring surface), there is, at the distance 18, a permanent magnetic ring 17b with an oppositely directed magnetic field (the outer ring surface of the permanent magnetic rings 17b forms the magnetic south pole). In this way, torus-like rotational symmetric permanent magnetic fields B0 are generated on the cylinder surface 5 around the measuring range 16 of the cylindrical measuring body between permanent magnetic rings 17, which can penetrate the material disposed on the cylinder surface of the measuring body.

At one side of the measuring body 1, as shown in FIG. 1, the rotational symmetric permanent magnetic ring fields B0 are schematically indicated.

In the cylindrical measuring area on the measuring body 1 electrical gradient coils 19 and radio frequency coils 20 are provided; the coils are also disposed adjacent to one another in the form of a ring. By means of the radio frequency coils, a pulsed magnetic measuring field B1 can be superimposed on the permanent magnetic ring field B0 of the permanent magnetic rings as a magnetic component of a radio frequency field. With the gradient coils 19, additionally a pulsed gradient field BG extending tangentially to the cylinder surface 5 with a gradient normal to the permanent magnet ring field B0 is generated in the measuring sensitive volume area.

As apparent from FIG. 1, the gradient coils 19 which are arranged on the measuring body 1 between the permanent magnet rings 17—corresponding to the axis-parallel arrangement of the permanent rings—are disposed with their coil axes 21 parallel to the cylinder axis 15. With this orientation of the gradient coils, the permanent magnet field B0 can be individually influenced by the gradient fields BG generated by the gradient coils. Sector areas of the permanent magnet rings 17 which are delimited by adjacent gradient coils 19 form, together with these gradient coils and the radio frequency coil 20 disposed between the gradient coils 19, a NMR-MOUSE probe. Each gradient coil is consequently associated with two adjacent NMR-MOUSE probes.

In the embodiment of FIG. 1, four permanent magnet rings 17 are disposed on the cylindrical measuring body 1 spaced from one another in the direction of the axis 15 of the cylinder body 1. As a result, three torus-like rotation-symmetrical polarization fields B0 are generated in the measuring area 16 on the cylinder surface 5 of the measuring body 1 by the radially polarized permanent magnet rings 17 with adjacent permanent magnet rings having opposite field directions. Between the permanent magnet rings 17, there are three probe rings 22, 23, 24 with gradient and radio frequency coils 19 and 20, respectively. In FIG. 1, the NMR-MOUSE probes, which are formed by each probe ring and disposed in each ring adjacent to, and oriented normal to, the orientation of the reinforcement fibers, are provided with the reference numeral 9a for the NMR-MOUSE probes in the probe ring 22, the reference 9b for the NMR-MOUSE probes in the probe ring 23 and the reference 9c for the NMR-MOUSE probes in the probe ring 24.

In the embodiment shown, the shape and size of the measuring body 1 is adapted to the dimensions of flat goods to be examined. The NMR-MOUSE probes are so designed that flat goods can be examined the textile reinforcements of which are at least 0.1 mm thick and are embedded in the polymeric material at a depth of 0.2 to 5 mm below the surface. The measuring body 1 shown in FIG. 1 is designed for examining a pneumatically loaded hose-like elastomer structure of a thickness of 2 mm with a reinforcement of 0.2 to 0.5 mm thick polyamide fibers which extend through the center of the polymeric material sheet at a depth of 1 mm and in a longitudinal direction of the hose. They are arranged parallel to one another and at a distance of 0.5 to 1 mm. The diameter of the measuring body 1 with the permanent magnet rings 17 is 80 mm; it is adapted to the diameter of the hose-like structure. The ring thickness 26 of the permanent magnetic rings in the direction of the cylinder axis 15 is 20 mm. The distance 18 between the permanent magnet rings 17 for receiving the gradient and radio frequency coils 19 and 20 is 13 mm. Altogether, 12 NMR-MOUSE probes are arranged in each ring 22 to 24 of the particular embodiment shown in FIG. 1 distributed over the circumference of the measuring body 1.

The NMR-MOUSE probes 9a, 9b, 9c are arranged in ring planes of the three probe rings 22 to 24 of the measuring body 1, that is, in the direction of the cylinder axis, from the probe ring 22 to the probe ring 24 so as to be displaced with respect to each other by an angle 27. I this way the measuring sensitive areas of the NMR-MOUSE probes 9a, 9b, 9c overlap in order to examine the hose-like material in the measuring range 16 over the whole circumference. The parallel arrangement of the textile reinforcement fibers in the polymeric material can be fully examined in this way in a single passage.

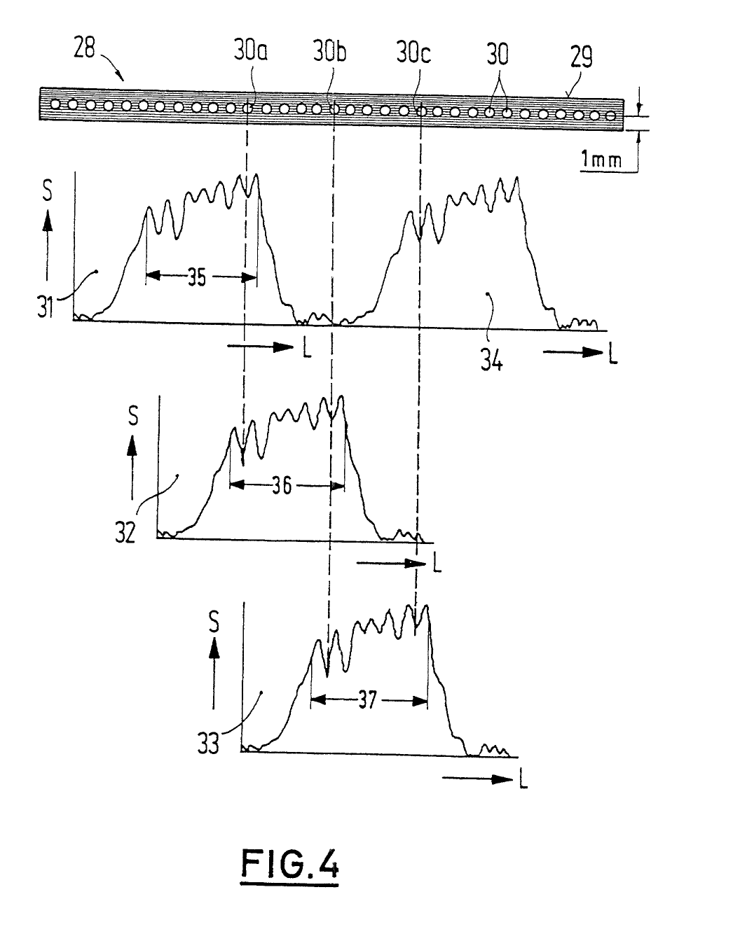

For an explanation concerning the overlapping and the angular displacement of the NMR-MOUSE probes 9a, 9b, 9c from probe ring to probe ring, FIG. 4 shows four schematic measuring protocols 31, 32, 33, 34 of four NMR-MOUSE probes. Herein a cross-section of the flat good 28 of polymeric material 29 with the textile reinforcement fibers extending longitudinally in the hose-like structure parallel to the cylinder axis 15 and in spaced relationship, which were examined by the probes, is represented. The measuring protocols indicate on the ordinate the measured values of the signal amplitude S depending on the material width L, which is indicated on the base. The material width is the dimension of the width examined by the NMR-MOUSE probes during measuring.

The polymeric material including the textile reinforcements consists—with respect to the NMR analysis concerning the concentration of the nuclear magnetic core 1H to be determined of material areas which provide for a strong NMR signal (because of high 1H—or 19F densities or long transverse relaxation times) in the areas which consist solely of elastomer material and of material areas which provide little or no signals, that is areas in which textile reinforcements are disposed in the elastomer material. In the embodiment shown, the textile reinforcements are polyamide fibers. Because of these very different nuclear magnetic properties of the material areas the location of the reinforcement structure 30 in the polymeric material can be determined from the measuring protocol by reduced signal amplitude S, that is by low points of the measurement value S over the measuring length L. FIG. 1 shows the coordination between the location of the reinforcement structure in the polymeric material and the measurement values obtained.

From the measuring protocols 31 to 34 of FIG. 4, it is also apparent that the relevant sensitive measuring range of a NMR-MOUSE probe is limited to a core area which is smaller than the area covered by an NMR-MOUSE probe on a probe ring between two gradient coils 19. In FIG. 4, the intervals usable for the analysis of the flat goods are indicated in the measuring protocols as characteristic values for the measuring sensitive areas 35, 36, 37 of the three NMR-MOUSE probes 9a, 9b, 9c and marked by the reference numerals of the areas. Outside of these measuring sensitive areas 35, 36, 37, there are, because of the design and the arrangement of the NMR-MOUSE probes, dead spaces in which no measurements can be taken. Consequently, material analysis results over the whole circumference of the cylindrical measuring area cannot be obtained readily by NMR-MOUSE probes arranged only in a single probe ring as the measuring sensitive areas of adjacent NMR-MOUSE probes do not adjoin one another without gaps.

In the embodiment according to FIG. 1, these dead spaces of the individual NMR-MOUSE probes are bridged by a displacement of the probes in the different probe rings. The NMR-MOUSE probes in one probe ring are angularly displaced with respect to those in an adjacent probe ring. In the embodiment shown, they are displaced by an angle 27, so that at least the outermost reinforcement structure which is still covered by the measuring sensitive area of a NMR-MOUSE probe, is also covered by the measuring sensitive area of the angularly displaced NMR-MOUSE probe of the next probe ring. With such a duplicate measurement of the respective outermost reinforcement structure in the fringe areas of the measuring sensitive area, the measurement values of the various NMR-MOUSE probes can be verifiably joined for a complete analysis of the flat goods and for determining the locations and distances 8 of the reinforcement structures over the full circumference of the measuring body 1. In FIG. 4, the reinforcement structure 30a is determined by the measurement sensitive area 35 of the NMR-MOUSE probe 9a in the probe ring 22 (see FIG. 1) as well as by the measurement sensitive area 36 of the NMR-MOUSE probe 9b in the probe ring 23. In the same way, the NMR-MOUSE probes 9b and 9c in the probe rings 23 and 24 are arranged angularly displaced with respect to the reinforcement structure. The reinforcement structure 30b is measured in the end area of the measuring sensitive area 26 and also in the end area of the measuring sensitive area 37. The outer reinforcement area 30c, which is the last to be scanned by the NMR-MOUSE probe 9c is also scanned by the NMR-MOUSE probe 9a in the probe ring 22. In this way, a complete picture of the material cross-section over the whole circumference of the hose-like flat good can be obtained.

In the embodiment of FIG. 1, the NMR-MOUSE probes are all identical and all displaced by the same angle 27. It is noted however, that the angle 27, which is normally chosen for an overlapping of the measuring ranges, may also be selected to be smaller than given in the example. With a smaller angle, more than one, that is several, of the reinforcement fibers may be measured by two annularly adjacent NMR-MOUSE probes in the overlap ranges of the measuring sensitive areas.

The NMR-MOUSE probes are so designed that they can be alternately controlled so that, after taking a measurement with one of the NMR-MOUSE probes, during the relatively long period for building up the measuring signal (signal build-up time about 300 ms) the largest part of the measuring hardware which is needed for the control of the gradient and radio frequency coils, can be used already for receiving other data from another one of the NMR-MOUSE probes. This altogether reduces the time needed for the analysis of the material. To achieve this result, fast switches are required which are suitable not only for the switching between sending and receiving in a particular probe but also for switching over from probe to probe.

In the center of a radio frequency coil 20 of the measuring body 1, there are shown in the embodiment, openings 38a of an air passage 38, which can be either pressurized or evacuated. For examining and measuring the material, the hose-like flat good 3, which is disposed around the cylindrical surface 5 of the measuring body 1, is pulled by a vacuum into firm engagement with the cylindrical surface of the measuring body. After a measurement has been taken, a pressure is applied so that the hose is lifted off and can be moved to the next measuring position.

FIG. 2 shows a section of a planar measuring body 2 for material sheets 4. The measuring body 2 is designed like the measuring body 1. Instead of a cylindrical measuring area however, a planar measuring area 6 is provided which is formed by block-like permanent magnets 40 with planar pole faces N and, respectively, S. Between the permanent magnets 40 radio frequency- and gradient coils 41, 42 are disposed. The measuring body 2 includes four oppositely polarized permanent magnet blocks 40 with three probe zones 43, 44, 45, in which the NMR-MOUSE probes are again displaced with respect to one another in such a way that the structure of the material sheets 4 to be examined is completely covered in the measuring area of the measuring body 2.

The permanent magnets for generating the polarization fields B0 used in the embodiment can be replaced by electromagnets or by superconductive or high-temperature superconductive magnets. The gradient coils used provide for a one-dimensional resolution in tangential direction on the measuring surface, on which the flat goods are disposed with additional gradient coils, the measurements could be expanded for a two-dimensional resolution.

What is claimed is:

1. An apparatus for examining flat goods of polymeric material having reinforcement structures embedded therein, said apparatus including NMR-MOUSE (Nuclear Magnetic Resonance MObile Universal Surface Explorer) probes for a nuclear magnetic analysis of the flat goods.

2. An apparatus according to claim 1, comprising a measuring body including a measuring surface area formed by NMR-MOUSE probes for engagement with said flat goods during examination.

3. An apparatus according to claim 2, wherein said NMR-MOUSE probes are disposed at said measuring surface in an arrangement in which they overlap.

4. An apparatus according to claim 3, wherein said NMR-MOUSE probes have predetermined measurement-sensitive ranges and are so arranged that their measurement sensitive ranges overlap.

5. An apparatus according to claim 1, wherein said reinforcement structure comprises reinforcement filaments disposed in parallel within said polymeric material and said NMR-MOUSE probes are arranged adjacent one another in a direction normal to said filaments.

6. An apparatus according to claim 1, wherein said flat goods comprises a hose-like body and said apparatus consists of a cylindrical body with an annular measuring area in which said NMR-MOUSE probes are arranged for examining said hose-like body.

7. An apparatus according to claim 1, wherein said flat goods are examined at a warm state.

8. An apparatus according to claim 1, wherein said NMR-MOUSE probes are alternately controllable for providing measuring signals in succession.
